(19) United States
(12) Patent Application Publication
(10) Pub. No.: US 2011/0000891 A1
(43) Pub. Date: Jan. 6, 2011

(54) Heating device for a turbine blade and welding method

(76) Inventors: Bernd Burbaum, Ubach-Palenberg (DE); Selim Mokadem, Dusseldorf (DE); Norbert Pirch, Aachen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/866,302

(22) PCT Filed: Jan. 13, 2009
(86) PCT No.: PCT/EP09/50314

§ 371 Date: Aug. 5, 2010

(30) Foreign Application Priority Data
Feb. 8, 2008 (DE) 10 2008 008 049.7

(51) Int. Cl. B23K 11/00; B23K 26/00

(52) U.S. Cl. 219/78.01; 219/121.64

(57) ABSTRACT

During the welding of components, the components are preheated to avoid stresses. A device is provided for heating a turbine blade or vane in that a heating coil is arranged in a particular manner to obtain a temperature gradient in a component. A process for welding a turbine blade or vane is also provided.

### CROSS REFERENCE TO RELATED APPLICATIONS

This application is the US National Stage of International Application No. PCT/EP2009/050314, filed Jan. 13, 2009 and claims the benefit thereof. The International Application claims the benefits of German application No. 10 2008 008 049.7 DE filed Feb. 8, 2008. All of the applications are incorporated by reference herein in their entirety.

### FIELD OF INVENTION

The invention relates to a heating device for a turbine blade or vane and to a welding process.

### BACKGROUND OF INVENTION

Components such as turbine blades or vanes are often welded in order to re-melt cracks or to apply material. Since material is melted during the welding, thermal stresses occur between the molten region and the relatively cold, non-molten regions of the component. The component is therefore preheated to a specific temperature, in order to reduce such stresses.

However, it is often the case that the desired temperature or the desired temperature distribution is not achieved.

### SUMMARY OF INVENTION

It is therefore an object of the invention to overcome the above-mentioned problem.

The object is achieved by a device as claimed in the claims and by a process as claimed in the claims

The dependent claims list further advantageous measures which can be combined with one another, as desired, in order to obtain further advantages.

### BRIEF DESCRIPTION OF THE DRAWINGS

FIGS. 1-4 show various views of a heating device,

FIG. 5 shows a gas turbine,

FIG. 6 shows a perspective view of a turbine blade or vane,

FIG. 7 shows a list of superalloys.

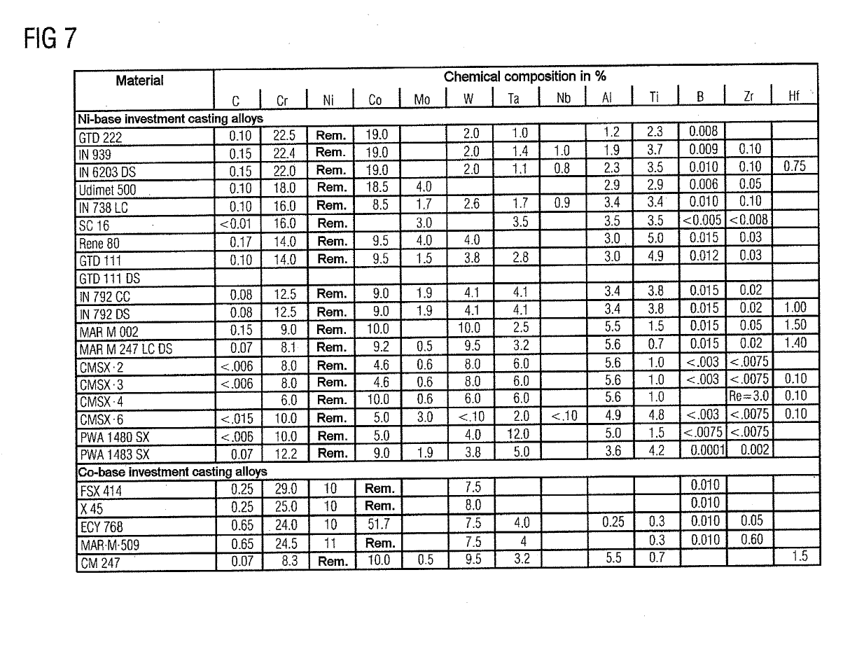

The figures and the description represent only exemplary embodiments of the invention.

### DETAILED DESCRIPTION OF INVENTION

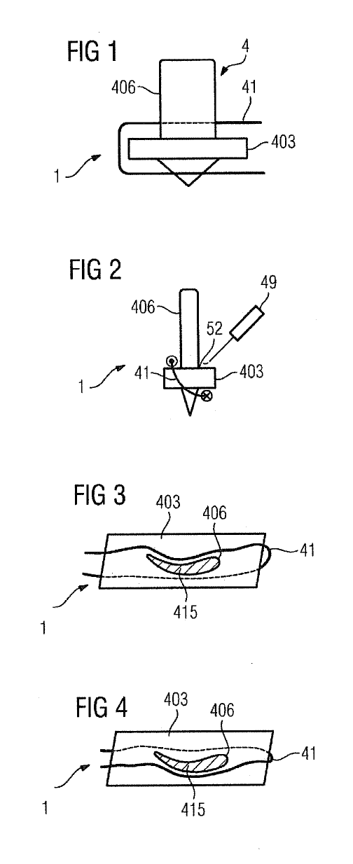

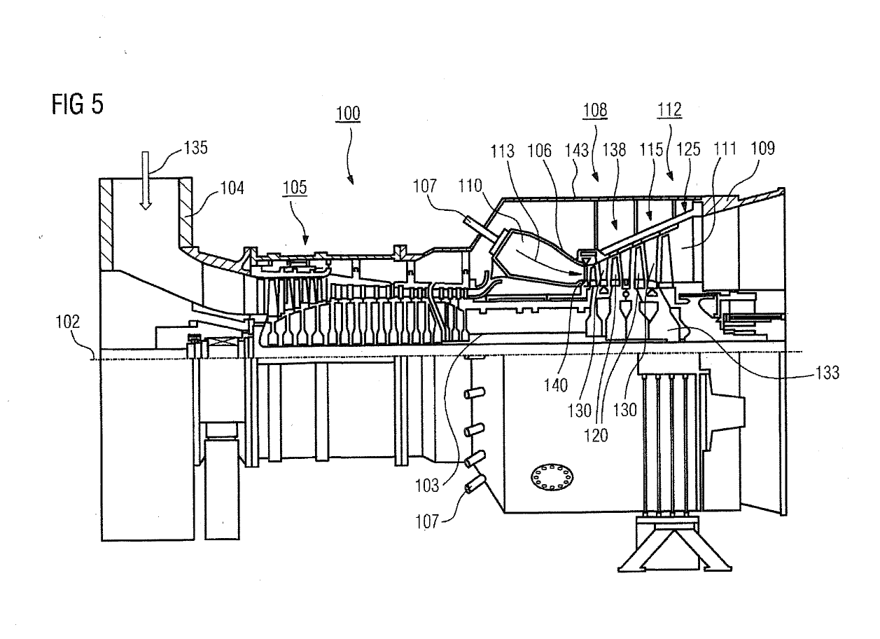

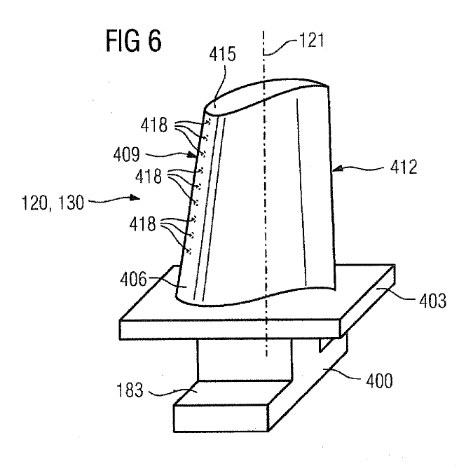

FIG. 1 shows a heating device 1 according to the invention, which has a receptacle (not shown in more detail) for a turbine blade or vane 4, 120, 130 (FIGS. 5, 6).

The turbine blade or vane 4, 120, 130 has a main blade or vane part 406 (FIG. 6) and at least one blade or vane platform 403 (FIG. 6). In the case of a rotor blade 120, only one blade platform 403 is present.

The heating device 1 has a heating wire 41 guided around the turbine blade or vane 4, 120, 130.

It is preferable for only a single heating loop 41 to be used. This represents a simple reproducible arrangement.

The heating wire 41 preferably extends both above the platform 403, preferably in the region of the main blade or vane part 406, and below the blade or vane platform 403, i.e. in the region of the securing region 400. Two regions of the heating wire 41 of the turbine blade or vane 120, 130 are therefore arranged diagonally in relation to one another.

FIG. 2 shows a view of FIG. 1, rotated through 90°.

As described in FIG. 1, the heating wire 41 extends both above and below the blade or vane platform 403. It preferably extends below the platform on that side where there is a welding appliance 49 for welding.

The heating loop 41 extends above the blade or vane platform 403 preferably as far as possible on or in the closest possible proximity to the blade or vane platform 403 and/or preferably in the closest possible proximity to the main blade or vane part 406.

Above the blade or vane platform 403, the heating wire 41 is arranged on that side of the main blade or vane part 406 which is remote from the welding appliance 49.

The heating loop 41 extends below the blade or vane platform 403 preferably as far as possible underneath or in the closest possible proximity to the blade or vane platform 403 and/or preferably in the closest possible proximity to the blade or vane root 400.

A curved transition region 52 between the main blade or vane part 406 and the blade or vane platform 403 is preferably welded.

The temperature gradient extends from the transition 52 obliquely with respect to the longitudinal axis 121 (FIG. 6) of the turbine blade or vane 120 in the direction of the blade or vane root 400.

This arrangement of the heating wire 41 means that a temperature gradient is obtained in the region 52, the transition between the main blade or vane part 406 and the blade or vane platform 403.

FIG. 3 shows a plan view of FIG. 1.

The main blade or vane part 406 is shown in cross section, said part 406 in its cross section providing a small region of the surface of the blade or vane platform 403. The main blade or vane part 406 has an inwardly and outwardly curved surface, i.e. a suction side and a pressure side. The heating wire 41 is preferably curved in the region of the main blade or vane part 406 according to said geometry, i.e. does not extend in a straight line.

On the underside of the blade or vane platform 403, as shown by dashed lines, the heating wire 41 can likewise preferably have a curved form, even if the securing region 400 does not necessarily have the same curved geometry as the main blade or vane part 406 above the platform 403.

The heating wire 41 can be guided above the blade or vane platform 403 either along the pressure side (FIG. 3) or along the suction side (FIG. 4).

This heating device 1 is preferably used for the welding.

In this case, use is made of a welding appliance 49 arranged on that side of the turbine blade or vane 120, 130 where the heating wire 41 extends below the blade or vane platform 403.

Welding can be performed both on the suction side and on the pressure side. The heating loop 41 is arranged accordingly.

A curved transition region 52 between the main blade or vane part 406 and the blade or vane platform 403 is preferably welded, said region having a temperature gradient.

The turbine blade or vane 120, 130 preferably has a DS or SX structure, a DS or SX structure likewise preferably being obtained in the welded region by virtue of the temperature gradient.

A magnetic powder, in particular a magnetic and dielectric powder, is preferably applied to the turbine blade or vane 120, 130, and this powder serves as a concentrator for the heating loop 41 during the heating. In this case, powder is applied over a large area (but not the entire turbine blade or vane 120, 130 or not the entire main blade or vane part 406) of the heating loop 41. Regions to be welded are left out in this process.

FIG. 5 shows, by way of example, a partial longitudinal section through a gas turbine 100.

In the interior, the gas turbine 100 has a rotor 103 with a shaft which is mounted such that it can rotate about an axis of rotation 102 and is also referred to as the turbine rotor.

An intake housing 104, a compressor 105, a, for example, toroidal combustion chamber 110, in particular an annular combustion chamber, with a plurality of coaxially arranged burners 107, a turbine 108 and the exhaust-gas housing 109 follow one another along the rotor 103.

The annular combustion chamber 110 is in communication with a, for example, annular hot-gas passage 111, where, by way of example, four successive turbine stages 112 form the turbine 108.

Each turbine stage 112 is fanned, for example, from two blade or vane rings. As seen in the direction of flow of a working medium 113, in the hot-gas passage 111 a row of guide vanes 115 is followed by a row 125 formed from rotor blades 120.

The guide vanes 130 are secured to an inner housing 138 of a stator 143, whereas the rotor blades 120 of a row 125 are fitted to the rotor 103 for example by means of a turbine disk 133.

A generator (not shown) is coupled to the rotor 103.

While the gas turbine 100 is operating, the compressor 105 sucks in air 135 through the intake housing 104 and compresses it. The compressed air provided at the turbine-side end of the compressor 105 is passed to the burners 107, where it is mixed with a fuel. The mix is then burnt in the combustion chamber 110, forming the working medium 113. From there, the working medium 113 flows along the hot-gas passage 111 past the guide vanes 130 and the rotor blades 120. The working medium 113 is expanded at the rotor blades 120, transferring its momentum, so that the rotor blades 120 drive the rotor 103 and the latter in turn drives the generator coupled to it.

While the gas turbine 100 is operating, the components which are exposed to the hot working medium 113 are subject to thermal stresses. The guide vanes 130 and rotor blades 120 of the first turbine stage 112, as seen in the direction of flow of the working medium 113, together with the heat shield elements which line the annular combustion chamber 110, are subject to the highest thermal stresses.

To be able to withstand the temperatures which prevail there, they may be cooled by means of a coolant.

Substrates of the components may likewise have a directional structure, i.e. they are in single-crystal form (SX structure) or have only longitudinally oriented grains (DS structure).

By way of example, iron-base, nickel-base or cobalt-base superalloys are used as material for the components, in particular for the turbine blade or vane 120, 130 and components of the combustion chamber 110.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloys.

The guide vane 130 has a guide vane root (not shown here), which faces the inner housing 138 of the turbine 108, and a guide vane head which is at the opposite end from the guide vane root. The guide vane head faces the rotor 103 and is fixed to a securing ring 140 of the stator 143.

FIG. 6 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406. In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949; these documents form part of the disclosure with regard to the chemical composition of the alloy.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1; these documents form part of the disclosure with regard to the solidification process.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1, which are intended to form part of this disclosure with regard to the chemical composition of the alloy.

The density is preferably 95% of the theoretical density.

A protective aluminum oxide layer (TGO=thermally grown oxide layer) is formed on the MCrAlX layer (as an intermediate layer or as the outermost layer).

The layer preferably has a composition Co—30Ni—28Cr—8Al—0.6Y—0.7Si or Co—28Ni—24Cr—10Al—0.6Y. In addition to these cobalt-base protective coatings, it is also preferable to use nickel-base protective layers, such as Ni—10Cr—12Al—0.6Y—3Re or Ni—12Co—21Cr—11Al—0.4Y—2Re or Ni—25Co—17Cr—10Al—0.4Y—1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer.

Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

The blade or vane 120, 130 may be hollow or solid in form. If the blade or vane 120, 130 is to be cooled, it is hollow and may also have film-cooling holes 418 (indicated by dashed lines).

1.-15. (canceled)

16. A device for heating a turbine blade or vane, comprising:
a heating loop guided around the turbine blade or vane,
wherein the heating loop is arranged in order to obtain a temperature gradient.

17. The device as claimed in claim 16, wherein the temperature gradient is obtained in a main blade or vane part.

18. The device as claimed in claim 16, wherein the heating loop is guided above a blade or vane platform and beneath a blade or vane platform in the turbine blade or vane.

19. The device as claimed in claim 16, wherein the heating loop is curved above the blade or vane platform in a region of the main blade or vane part.

20. The device as claimed in claim 19, wherein the heating loop is curved above the blade or vane platform in the region of the main blade or vane part according to a curvature of the main blade or vane part.

21. The device as claimed in claim 16, wherein the heating loop is curved beneath the platform.

22. The device as claimed in claim 21, wherein the heating loop is curved beneath the platform according to the curvature of the main blade or vane part above the blade or vane platform.

23. The device as claimed in claim 21, wherein the device includes only a single heating loop.

24. The device as claimed in claim 17, wherein the heating loop is guided in a proximity of the blade or vane platform.

25. The device as claimed in claim 24, wherein the heating loop is guided in the proximity of the main blade or vane part or of the blade or vane root.

26. The device as claimed in claim 25, wherein the heating loop is arranged on a suction side of the main blade or vane part.

27. The device as claimed in claim 25 wherein the heating loop is arranged on a pressure side of the main blade or vane part.

28. The device as claimed in claim 16, wherein the device is a part of a device for welding a turbine blade or vane.

29. A process for welding a turbine blade or vane, comprising:
using a welding appliance to produce a weld seam.

30. The process as claimed in claim 29, wherein the welding appliance is a laser.

31. The process as claimed in claim 29,
wherein the welding takes place on a side of the turbine blade or vane, and
wherein a heating loop extends beneath a turbine blade or vane platform.

32. The process as claimed in claim 29, wherein a weld seam is allowed to solidify directionally in a DS or SX structure.

33. The process as claimed in claim 29,
wherein a transition region between a main blade or vane part and the blade or vane platform is welded.

34. The process as claimed in claim 29,
wherein a magnetic powder is applied in a region to be heated.

35. The process as claimed in claim 34, wherein the magnetic powder is dielectric.
